(19) United States
(12) Patent Application Publication
(10) Pub. No.: US 2011/0036762 A1
(43) Pub. Date: Feb. 17, 2011

(54) Digester gas mixer for waste liquid treatment

(76) Inventors: Richard J. Koopmans, Bellevue, WA (US); Kristinn G. Drewry, Bellevue, WA (US)

Correspondence Address: Anthony Claiborne, 849 136th Ave. N.E., Bellevue, WA, 98005, US

(21) Appl. No.: 12/462,990

(22) Filed: Aug. 12, 2009

(51) Int. Cl. C02F 3/28

(52) U.S. Cl. 210/188; 210/220; 210/603

(57) ABSTRACT

A mixer for anaerobic decomposition of sludge in a digester, captures and compressed biogas emitted by the decomposing sludge. The compressed biogas proceeds through supply lines to bubble forming plates mounted in the lower portion of the digester, close to or on the digester floor. Biogas accumulates under the forming plates to emerge as large mixing bubbles from 6 inches to 10 feet in diameter along their largest dimension. The mixing bubbles are large enough to move sludge as they rise to the surface and generate a mixing current in the sludge. The mixing current mixes the sludge, and bacteria and other microorganisms to promote the conversion of the pollutants contained in the sludge.

### BACKGROUND OF THE INVENTION

1. Field of the Invention

This invention relates to mixers for mixing liquids by the injection of gas to form large mixing bubbles. More specifically, this invention relates to utilizing biogas for such mixers employed in the anaerobic decomposition of waste liquids.

2. Description of the Related Art

Water is frequently used to transport unwanted materials—waste—to a facility where the waste is removed or neutralized in the water. For example, water carries most sewage and industrial waste, such as chemicals, in the form of wastewater to a treatment facility where the water is treated and then returned to the environment for future use. Wastewater treatment is a subset of waste liquid treatment generally, in which liquid with dissolved and suspended toxins, high solids and high biological oxygen demand is decomposed to yield more environmentally friendly material.

Such liquid waste treatment processes involve sequential separation of waste components from the liquid waste. Of central concern in the treatment of liquid waste is the removal of solid components of the waste liquid. Solid waste components in liquid waste may be categorized as settleable solids, suspended solids, and dissolved solids. Referring to FIG. 1, depicted is a diagram illustrating a typical liquid waste treatment process. Raw waste 102, comprising water with both organic and inorganic waste is submitted to pretreatment 104, in which gross untreatable solids 106 such as rock, grit and plastic, are separated from the stream of waste. The resulting pre-treated liquid waste 108, comprised of water with fine settleable solids, suspended solids and dissolved solids is placed in a settling tank or primary clarifier 110, in which settleable solids in the waste are allowed to settle out. The settleable solids 112 that have settled to the bottom of primary clarifier are then transported to a digester 114.

With the removal of settleable solids 112 from primary clarifier 110, the supernatant fluid 122, comprised of water with suspended and dissolved solids, is transported to a secondary treatment facility 124, which typically includes an aerobic—with oxygen—portion in which bacterial and other microorganisms are provided dissolved oxygen to promote their consumption of the carbonaceous and nutrient materials, and an anoxic—oxygen from a nitrate/nitrite source—portion in which the bacteria and other microorganisms use the oxygen in the nitrate/nitrite for their metabolic functions. The biological processing of the waste liquid in the secondary treatment facility 124 results in a liquid 126 consisting principally of microbes as settleable biological material and water substantially depleted of biologically active organic pollutants.

After biological remediation in secondary treatment facility 124, liquid 126 is transported to secondary clarifier 128, in which the settleable semi-solid biological material is allowed to settle out, resulting in biological sludge 130 which is transported to digester 114. The supernatant fluid 132 is transported from tank 128 as effluent in which a substantial portion of inorganic and organic pollutants have been removed by the foregoing described treatment process.

The present invention is directed toward digesters, such as digester 114 depicted in FIG. 1. In such digesters, sludge (comprised of settleable materials, obtained both before 112 and after 130 secondary treatment 124) is allowed to settle further, resulting in supernatant liquid 116 which is typically transported back through the liquid waste treatment process for further purification as described above. The remaining semi-solid sludge is further allowed to digest anaerobically in digester 114 in the absence of oxygen. In the digestion of sludge, organic compounds in the sludge are decomposed by fermentation activities of anaerobic microbes, to form biogas 120, consisting principally of methane (CH₄) and carbon dioxide (C0₂). These anaerobic microbes are principally mesophilic, metabolizing organic compounds optimally at temperatures in the range of about 95 to 105 degrees Fahrenheit. Accordingly, it is common practice to maintain decomposing sludge in this temperature range by circulating digester contents through heat exchangers.

The anaerobic decomposition of sludge reduces its potential toxicity to the environment, as measured by biological oxygen demand. When anaerobic decomposition has progressed sufficiently that the biological oxygen demand of the sludge has been reduced to an acceptable level, digested sludge 118 is removed from digester 114 and disposed of in the environment by various methods well known to those of skill in the liquid waste processing art.

It is important that the semi-solid sludge in the digester be mixed regularly to assure efficiency of the digestive process. While many waste treatment facilities simply rely on the circulation of sludge provided by heat exchange, as discussed above, various additional methods of mixing sludge in digesters have been employed in the prior art, each with various shortcomings.

Mechanical mixers, typically employing a screw or a blade, have been used to mix the sludge contents of digesters. While mechanical mixers are very common, they all require fairly large amounts of energy, typically in the form of electricity supplied to electric motors to drive the mixers. Further, such mixers are prone to mechanical failure. Yet further, many mechanical mixers are not thoroughly effective, failing to supply adequate mixing to all regions of the sludge in the digester, resulting in uneven biological decomposition of the sludge over time.

For secondary treatment of liquid waste, effective mixers, such as described in U.S. Pat. Nos. 7,524,419, 7,374,675 and 7,282,141 (all to the inventors of the present invention), have been developed that employ compressed gas, such as air, to form large mixing bubbles that generate currents that mix the waste liquid. Such mixers are much more efficient and trouble-free than mechanical mixers. However, bubble mixers using compressed gas containing oxygen, such as air, are not useable in digesters, because digesters rely for operation in large part on the activity of strictly anaerobic microbes, organisms which cannot function effectively in the presence of even relatively small amounts of oxygen. To provide the benefit of bubble mixing to digesters, what is needed is a bubble mixer employing gas that is essentially free of oxygen. By utilizing the gases emitted in anaerobic digestion of sludge, such a mixer can further realize significant economic efficiencies of operation.

In the Perth™ Digester Gas Mixer supplied by Siemens Water Technologies of Waukesha, Wis., biogas emitted in anaerobic sludge decomposition is collected and compressed to flow through large bore straight vertical pipes (called “lances”) depending into the sludge to various depths. The moderate turbulence in the digester caused by the emission of bubbles of biogas from the bottom openings of the lances is claimed to provide mixing of materials in the digester to facilitate decomposition.

The Perth and similar mixers, however, are subject to several limitations. First, in a typical installation, the Perth lances do not extend to the very bottom of the digester. Accordingly, whatever turbulence is caused by the bubbles emitted from the lances has little effect upon materials settled to the bottom of the digester. These materials remain essentially undisturbed, with no improvement in their decomposition brought about by use of the Perth technology. Second, while the bubbles emitted from the bottom opening of a Perth lance may create some turbulence as they rise through the upper portion of the digerster, the amount of turbulence caused by such bubbles is only a fraction of the turbulence observed to be caused by bubbles created in secondary waste liquid treatment using mixers with bubble forming plates such as described in U.S. Pat. Nos. 7,524,419, 7,374,675 and 7,282,141.

What is needed is an improved apparatus for mixing the contents of anaerobic liquid waste treatment tanks, employing bubble mixing technology in an effective manner to provide large anaerobic bubbles that mix materials in all levels of the tank.

### BRIEF SUMMARY OF THE INVENTION

Embodiments of the present invention comprise a mixer for anaerobic decomposition of sludge in a digester employed in waste liquid treatment, in which biogas emitted by the decomposing sludge is captured and compressed. The compressed biogas proceeds through supply lines to bubble forming plates mounted in the lower portion of the digester, close to or on the digester floor. Biogas accumulates under the forming plates to emerge as large mixing bubbles from 6 inches to 10 feet in diameter along their largest dimension. The mixing bubbles are large enough to move sludge as they rise to the surface and generate a mixing current in the sludge. The mixing current mixes the sludge, and bacteria and other microorganisms to promote the bacteria and other microorganisms' conversion of the pollutants contained in the sludge.

### BRIEF DESCRIPTION OF THE DRAWINGS

The foregoing objects, as well as further objects, advantages, features and characteristics of the present invention, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 depicts prior art liquid waste treatment, described above in reference to the background of the invention;

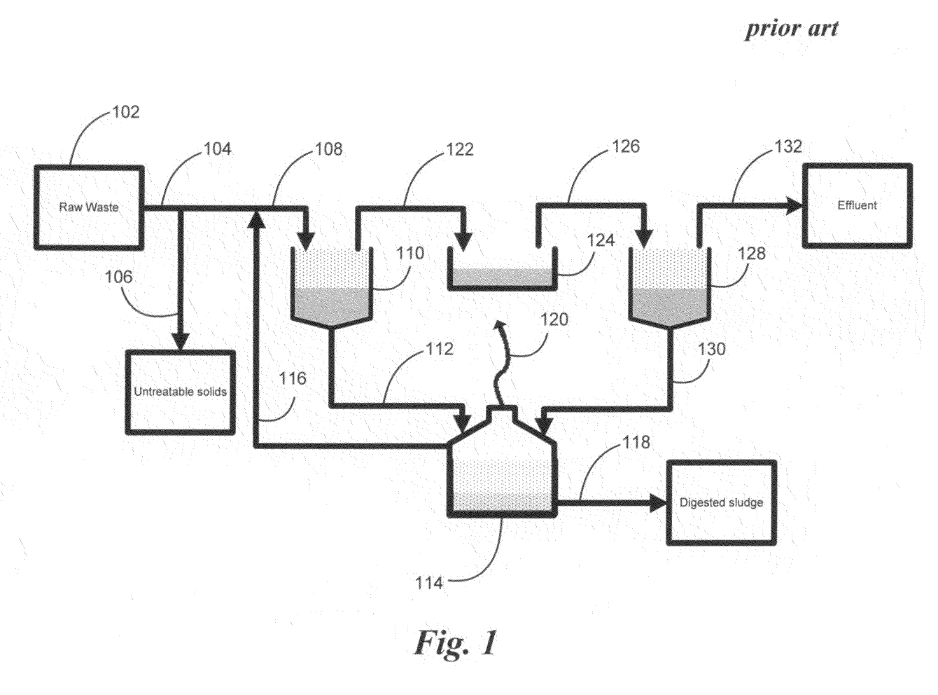

FIG. 2a is a perspective view of a bubble forming plate, according to an embodiment of the invention;

FIG. 2b is a perspective view of a bubble forming plate, according to another embodiment of the invention;

FIG. 3 is a diagrammatic layout of distribution lines and forming plates located and arranged in a digester, according to an embodiment of the invention;

FIG. 4 is a view of a digester containing a mixer according to the present invention, illustrating the mixing currents generated by large mixing bubbles; and

FIG. 5 depicts a closed digester in which biogas from the anaerobic decomposition of sludge is used to generate the large mixing bubbles according to an embodiment of the invention.

### DETAILED DESCRIPTION OF THE INVENTION

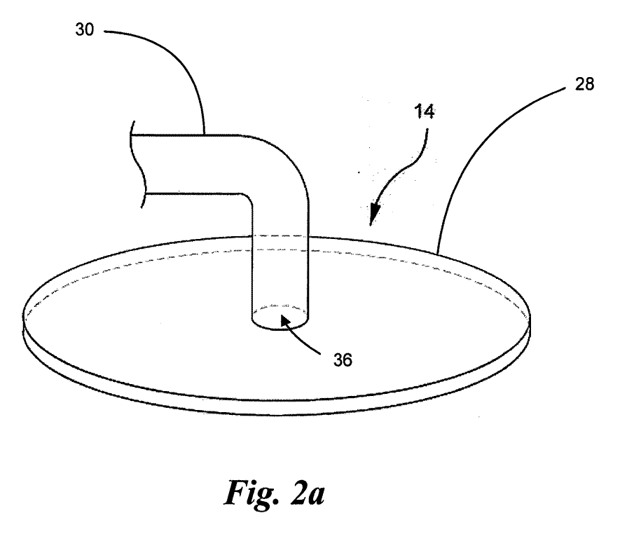

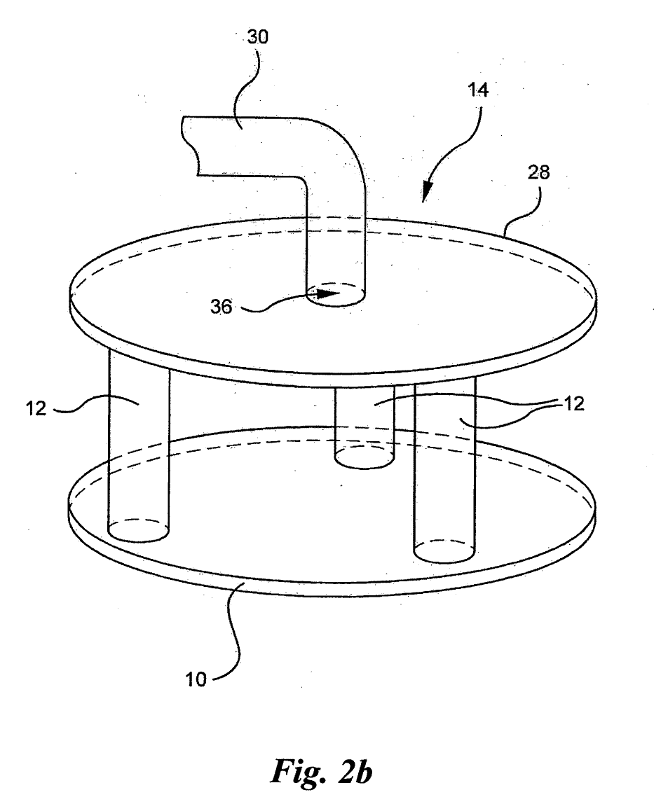

The present invention forms large mixing bubbles by use of bubble-forming plate assemblies that are placed in the digester in which mixing is desired. Turning to the assembly of such plates, FIG. 2a illustrates an embodiment of a bubble forming plate assembly 14 according to an embodiment of the present invention. Plate assembly 14 is immersed in sludge to be mixed. A gas distribution line 30 provides compressed gas through orifice 36 to the underside of plate 28. Plate 28 is typically made of corrosion resistant metal, or metal that has been treated for corrosion resistance, and in embodiments is on the order of eight inches in diameter. In any case, the gas, being lighter than the sludge, accumulates on the underside of plate 28 until such a large quantity has accumulated that it escapes around the edges of plate 28 to form a large bubble.

For effective mixing, plates are placed on or near the floor of the digester. An alternative embodiment of the bubble forming plate assembly 14 is illustrated in FIG. 2b, in which forming plate 28 sits upon a plurality of legs 12 which in turn are appended to a mounting plate 10. In this embodiment, mounting plate 10 rests on the bottom of the digester, in some embodiments held in place simply by the weight of plate assembly 14. In other embodiments, mounting plate 10 is affixed to the bottom of the digester by bolting, welding or other means of affixing well known to those in the art. In other embodiments, as described in U.S. patent application Ser. No. 12/290,661 by the inventors of the present invention, incorporated herein in its entirety by reference, mounting plate 10 is a strong permanent magnet which adheres to the bottom of any tank of ferromagnetic material.

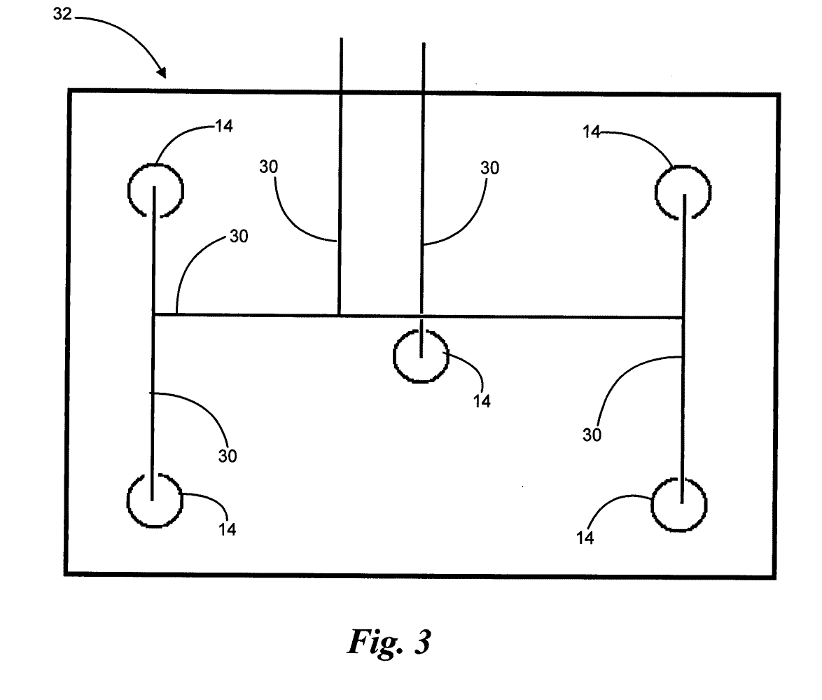

In any case, in typical installations of the present invention, a plurality of bubble forming plate assemblies are distributed throughout the lower portion of the digester. Turning to FIG. 3, illustrated is a diagrammatic layout of bubble forming plate assemblies in a digester 32. In the depicted embodiment, five bubble plate forming assemblies 14 are spaced throughout the bottom of digester 32, the assemblies 14 supplied by gas supply lines 30. As will be appreciated, the exact number and placement of plate assemblies 14 for any particular digester will be determined by the configuration of the digester 32 and the mixing requirements for treatment of the sludge.

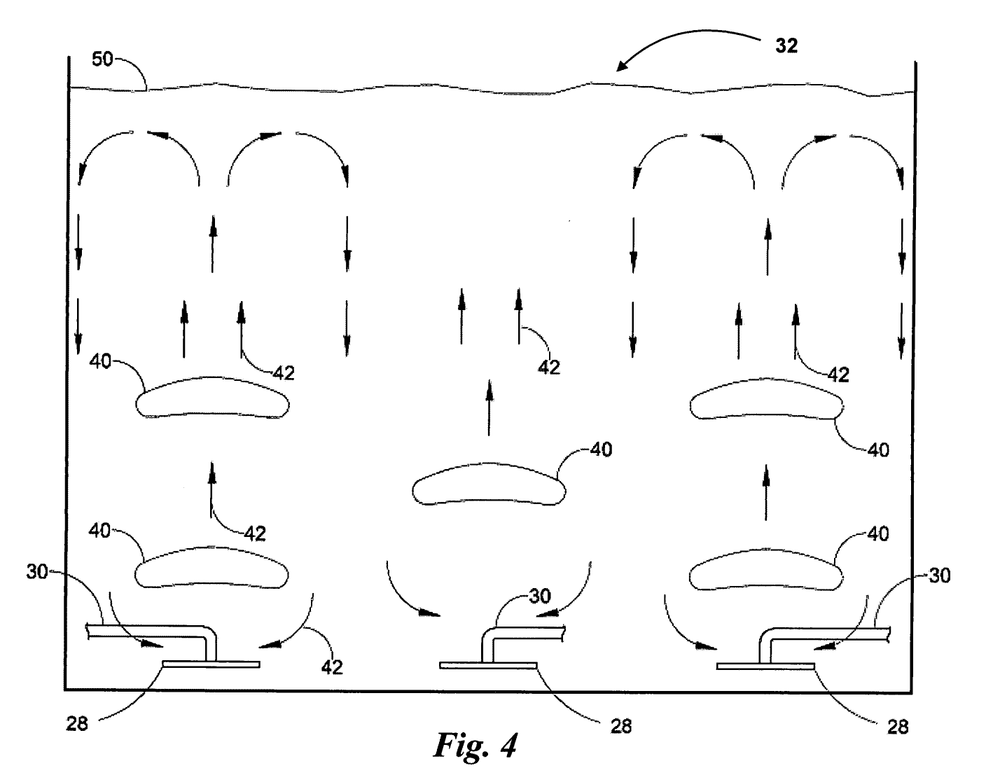

FIG. 4 depicts the mixing functionality provided by the present invention. Disposed in digester 32 are a plurality of bubble forming plates 28 (three depicted here). As described in reference to FIG. 2 above, compressed gas is supplied by supply lines 30 to accumulate on the underside of a plate 28 until such a large quantity has accumulated that it escapes around the edges of plate 28 to form a large bubble 40. The mixing bubbles 40 generate the mixing currents indicated by the arrows 42 (28 arrows shown but only 5 labeled with the reference number 42 for clarity) that mix the sludge 50, bacteria (omitted for clarity) and other microorganisms (also omitted for clarity). The strength of the mixing currents depends on the speed at which each mixing bubble 40 travels through the sludge and the size of each bubble 40.

The speed of the mixing bubble 40 depends on the density of the compressed gas relative to the density of the sludge 50, and the bubble's shape. The greater the difference between the densities of the sludge 50 and the compressed gas, the faster the mixing bubbles 40 rise through the sludge 50. The more aerodynamic the shape of the bubble 40 becomes the faster the bubble 40 rises through the sludge 50. For example, in one embodiment, the bubble 40 forms a squished sphere—a sphere whose dimension in the vertical direction is less than the dimension in the horizontal direction. In other embodiments, the bubble 40 forms a squished sphere having the trailing surface—the surface of the bubble 40 that is the rear of the bubble 40 relative to the direction in which the bubble 40 moves—that is convex when viewed from the direction that the bubble 40 moves.

The size of the mixing bubble 40 depends on the flow rate of the compressed gas into the sludge 50. The flow rate depends on the size of the orifice 36 (FIG. 2) and the gas injection pressure. As one increases the compressed gas injection pressure, one increases the amount of gas injected into the sludge 50 over a specific period of time that the valve 29 is open. And, as one increases the area of the orifice 36, one increases the amount of compressed gas injected into the sludge 50 over a specific period of time that the valve 29 is open. As one increases the diameter of the forming plate 28 one increases the amount of gas the forming plate 28 can hold before the gas escapes it. For example, in one embodiment the size of the bubble 40 is approximately 6 inches across its largest dimension. In other embodiments, the bubble 40 is approximately 10 feet across in largest dimension.

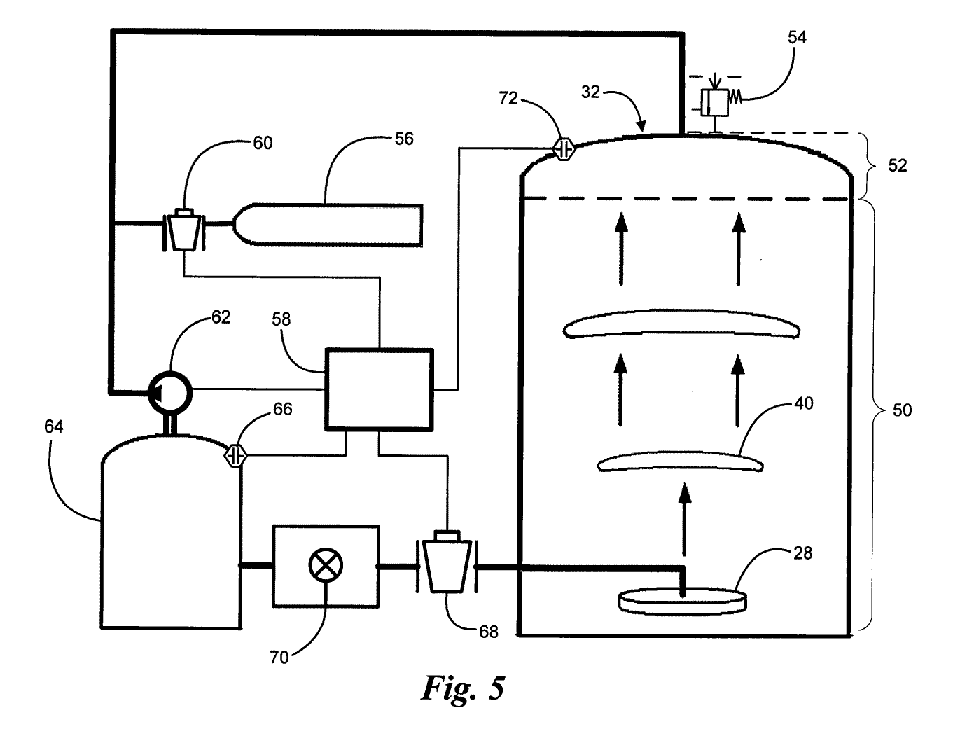

Turning now to FIG. 5, depicted is the use of the present invention to mix sludge in waste liquid treatment. Sealed digester 32 has been partially filled with sludge 50. Above the surface of sludge 50 is headspace 52 in which gas can accumulate. Digester 32 is fitted with pressure relief valve 54 to regulate the pressure of accumulated gas in headspace 52 to the range of gas pressure consistent with optimal growth of the digester anaerobic microbes. In some embodiments, pressure in headspace 52 is limited to 20 pounds per square inch or less of gas. Further, because of environmental concerns, if relief valve 54 vents significant quantities of biogas, provisions must be made for environmental remediation of such emissions (not depicted), by methods well known to those of skill in the art.

Digester 32 is further outfitted with bubble forming plates 28 as described in reference to earlier drawings (only one plate 28 illustrated here for the purpose of clarity).

When sludge 50 is first placed in digester 32, the population and activity of anaerobic microorganisms in sludge 50 generates little biogas. To provide mixing of sludge 50 in its early stages of anaerobic decomposition, the depicted embodiment of the invention employs an initial supply of anaerobic gas, such as carbon dioxide, in auxiliary gas pressure tank 56. During the early stages of anaerobic decomposition of sludge 50, a controller 58 opens a valve 60, providing gas from auxiliary gas pressure tank 56 to compressor 62. As anaerobic decomposition of sludge 50 in digester 32 progresses, anaerobic organisms in sludge 50 flourish and multiply, producing increasing amounts of biogas, which accumulates in headspace 52. When digester sensor 72 indicates that sufficient biogas has accumulated in headspace 52, biogas instead of gas from auxiliary gas pressure tank 56 is supplied to compressor 62 and controller 58 closes valve 60.

Compressor 62, under control of controller 58, is activated to supply pressurized gas to pressurized gas storage tank 64 when tank pressure sensor 66 indicates that the pressure of gas in pressurized gas storage tank 64 is below a predetermined lower bound. Compressor 62 continues to compress gas into pressurized gas storage tank 64 until tank pressure sensor 66 indicates the pressure of gas in pressurized gas storage tank 64 has reached a predetermined upper bound. As will be appreciated by those in the art, the predetermined values of tank pressure lower and upper bounds can vary widely depending upon the particulars of the embodiment, including the capacity of pressurized gas storage tank 60, efficient optimization of the duty cycle of compressor 62 and the volume of gas required over time by the particular implementation of the mixer of the present invention. Embodiments may utilize a lower bound of roughly 100 pounds of pressurized gas per square inch, while the upper bound may be determined by the operational limits of tank 64 and regulator 70 (discussed below).

To mix the contents 50 of digester 32, controller 58 periodically directs pulse valve 68 to open, whereby pressurized gas from pressurized gas storage tank 60, pressure regulated through regulator 70, flows through supply line 30 to accumulate under plate 28 to form large mixing bubbles 40, mixing the contents 50 of digester 32 by convection currents as described above in reference to FIG. 4. In some embodiments, regulator 70 controls the pressure of gas flowing through valve 68 to 40 to 60 pounds per square inch. For regulator 70, such embodiments may utilize the B20 and B21 QIX filter/regulators supplied by Parker-Hannifin Corp., Pneumatic Division of Richland, Mich. For pulse valve 68, embodiments utilize Type 2000 threaded port valve from Christian Bürkert GmbH & Co. KG of Ingelfingen, Germany.

As will be appreciated by those in the art, considerable variation and refinement of the embodiment described in the foregoing is possible while still keeping with the spirit of the present invention. For example, instead of employing the bubble mixer to mix sludge 50 in the early stages of anaerobic decomposition, a mechanical mixer may be used to mix sludge 50 until such time as sufficient biogas is produced by sludge 50 to operate the bubble mixer, thereby obviating the need for auxiliary gas pressure tank 56 and associated valve 60 altogether. Additionally, embodiments may be constructed wherein, when anaerobic decomposition of sludge 50 has progressed sufficiently that a quantity of biogas is produced, a portion of the biogas may be treated and used as fuel to power compressor 62 in a manner well known to those in the alternative energy arts.

Although the detailed descriptions above contain many specifics, these should not be construed as limiting the scope of the invention but as merely providing illustrations of some of the presently preferred embodiments of this invention. Various other embodiments and ramifications are possible within its scope, a number of which are discussed in general terms above.

While the invention has been described with a certain degree of particularity, it should be recognized that elements thereof may be altered by persons skilled in the art without departing from the spirit and scope of the invention. Accordingly, the present invention is not intended to be limited to the specific forms set forth herein, but on the contrary, it is intended to cover such alternatives, modifications and equivalents as can be reasonably included within the scope of the invention. The invention is limited only by the following claims and their equivalents.

I claim:

1. A system for mixing sludge from waste liquid treatment, the system comprising:
a digester containing at least one sludge treatment zone, the zone having an upper portion and a lower portion;
a mixer for generating large mixing bubbles within the lower portion of the sludge treatment zone, the mixer comprising:
a source of anaerobic gas;
at least one bubble forming plate disposed in the lower portion of the digester;
at least one supply line for transporting anaerobic gas from the source of anaerobic gas to the bubble forming plate; and
a valve within the supply line, the valve controllably supplying pulses of the anaerobic gas from the supply line to the underside of the bubble forming plate.

2. A system according to claim 1, further comprising a means for capturing and storing biogas obtained from the anaerobic decomposition of sludge in the digester, the source of anaerobic gas comprising such means.

3. A system according to claim 2, further comprising:
a means for detecting the quantity of stored biogas available for mixing the sludge;
an auxiliary tank of compressed anaerobic gas connected by a normally closed valve to the supply line,
wherein, when insufficient biogas is detected for mixing the sludge, the normally closed valve is opened and the source of anaerobic gas further comprises the tank.

4. A mixer for mixing sludge in a waste liquid treatment system digester, the digester having an upper portion and a lower portion, the mixer comprising:
at least one bubble forming plate disposed in the lower portion of the digester;
a means for capturing and storing biogas emitted by decomposing sludge in the digester, such means connected to provide stored biogas to at least one supply line, the supply line transporting gas to the bubble forming plate; and
a valve within the supply line, the valve supplying pulses of gas from the supply line to the underside of the bubble forming plate.

5. A mixer according to claim 4, further comprising:
a means for detecting the quantity of stored biogas available for mixing the sludge;
an auxiliary tank of compressed anaerobic gas connected by a normally closed valve to the supply line,
wherein, when insufficient biogas is detected for mixing the sludge, the normally closed valve is opened to provide anaerobic gas from the tank to the supply line.
